(19) United States
(12) Patent Application Publication
(10) Pub. No.: US 2011/0219779 A1
(43) Pub. Date: Sep. 15, 2011

(54) LOW EMISSION COMBUSTION SYSTEMS AND METHODS FOR GAS TURBINE ENGINES

(75) Inventors: Ian Critchley, Phoenix, AZ (US); Frank Joseph Zupanc, Phoenix, AZ (US)

(73) Assignee: HONEYWELL INTERNATIONAL INC., Morristown, NJ (US)

(21) Appl. No.: 12/721,774

(22) Filed: Mar. 11, 2010

(51) Int. Cl. F02C 9/00; F02C 7/22; F02C 3/14

(52) U.S. Cl. 60/773; 60/737; 60/740; 60/752

(57) ABSTRACT

A combustion system for a gas turbine engine is provided. The system includes a forward liner; an aft liner; a combustion chamber formed by the forward liner and the aft liner, the combustion chamber defining a lean combustion zone and a pilot combustion zone; a premixing zone coupled to the combustion chamber; a pilot fuel injector coupled to the combustion chamber and configured to deliver a first flow of fuel to the pilot combustion zone; and a slinger unit configured to deliver a second flow of fuel to the premixing zone such that the second flow of fuel is mixed with air in the premixing zone and directed into the lean combustion zone of the combustion chamber.

### TECHNICAL FIELD

This invention relates generally to combustion systems and methods for gas turbine engines, and more specifically to combustion systems and methods for gas turbine engines that reduce nitrogen oxide (NOx) emissions.

### BACKGROUND

In some aircraft, the main propulsion engines not only provide propulsion for the aircraft, but may also be used to drive various other rotating components such as, for example, generators, compressors, and pumps, to thereby supply electrical and/or pneumatic power. However, when an aircraft is on the ground, the main engines may not be operating. Moreover, in some instances, the main propulsion engines may not be capable of supplying the power needed for propulsion as well as the power to drive these other rotating components. Thus, many aircraft include one or more auxiliary power units (APUs) to supplement the main propulsion engines in providing electrical and/or pneumatic power.

An APU is, in most instances, a gas turbine engine that includes a compressor, a combustion system, and a power turbine. During operation, the compressor draws in ambient air, compresses it, and supplies compressed air to the combustion system. The combustion system receives fuel from a fuel source, mixes it with the compressed air, and ignites the resulting mixture to generate high-energy combusted air. The combusted air is directed into the power turbine. The power turbine includes a shaft that may be used to drive a generator for supplying electrical power and other components, including the compressor.

Conventional combustors operate near stoichiometric conditions of fuel to air ratios. In some instances, however, such conditions may produce higher than desired combustor temperatures because higher temperatures may produce nitrogen oxides (NOx). Environmental concerns and regulations have created the demand for gas turbine engines with reduced nitrogen oxide (NOx) emissions. However, attempts at lowering fuel to air ratios, and thus combustor temperatures, may be weighed with considerations for the operation of the combustor at low power conditions. That is, during starting conditions, the fuel to air ratio is greater than would otherwise be desired under full load conditions. These higher fuel to air ratios are desirable to maintain ignition performance in these conditions. As such, any attempt to reduce NOx emissions may result in insufficient low power performance.

Accordingly, it is desirable to develop a combustor that operates at a reduced temperature to reduce NOx emissions while providing desired ignition performance. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a combustion system for a gas turbine engine is provided. The system includes a forward liner; an aft liner; a combustion chamber formed by the forward liner and the aft liner, the combustion chamber defining a lean combustion zone and a pilot combustion zone; a premixing zone coupled to the combustion chamber; a pilot fuel injector coupled to the combustion chamber and configured to deliver a first flow of fuel to the pilot combustion zone; and a slinger unit configured to deliver a second flow of fuel to the premixing zone such that the second flow of fuel is mixed with air in the premixing zone and directed into the lean combustion zone of the combustion chamber.

In accordance with another exemplary embodiment, a method is provided for delivering fuel to a combustion chamber defining a lean combustion zone and a pilot combustion zone. The method includes delivering a first flow of fuel to the pilot combustion zone with a pilot fuel injector; delivering a second flow of fuel to a premixing duct coupled to the combustion chamber and defining a premixing zone; mixing the second flow of fuel with air to produce a lean fuel-air mixture; and delivering the lean fuel-air mixture to the lean combustion zone.

### BRIEF DESCRIPTION OF THE DRAWINGS

The present invention will hereinafter be described in conjunction with the following drawing figures, wherein like numerals denote like elements, and wherein:

FIG. 1 is a cross-sectional view of a gas turbine engine in accordance with an exemplary embodiment; and

FIG. 2 is a cross-sectional view of the combustion system of the gas turbine engine of FIG. 1 in accordance with an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Broadly, exemplary embodiments disclosed herein provide a gas turbine engine with combustion systems and methods generally optimized for both low power operations and reduced NOx emissions. A combustor of such systems and methods includes a pilot fuel injector for supplying fuel to a rich combustion zone in a combustion chamber. As the power load increases, additional fuel is provided by a slinger unit into a premixing zone for thorough mixing with air prior to combustion in a lean combustion zone. The operating temperature resulting from the lean ratios in the lean combustion zone during the increased power loads generates reduced NOx emissions. As such, the pilot zone maintains advantageous low power operations while the premixing and lean combustion zones provide higher power operations with reduced NOx emissions.

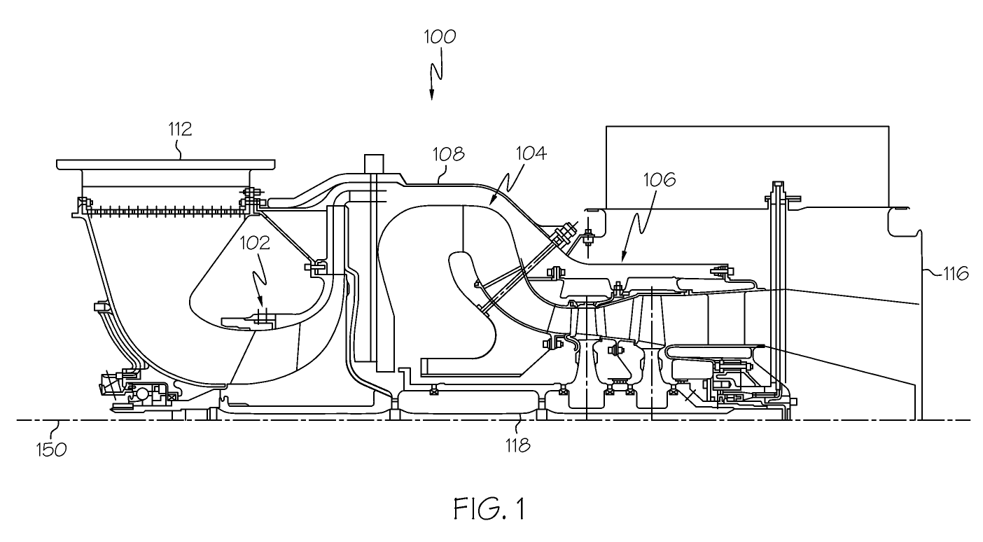

FIG. 1 is a cross-sectional view of a gas turbine engine 100 in accordance with an exemplary embodiment. In one exemplary embodiment, the engine 100 is an auxiliary power unit (APU) for an aircraft, although any suitable use or implementation of the exemplary embodiments discussed herein may be provided.

The engine 100 includes a compressor system 102, a combustion system 104, and a turbine system 106, each disposed within a case 108. In general, the view of FIG. 1 shows half of the engine 100 with the rest rotationally extended about longitudinal axis 150. In addition to the depicted engine 100, exemplary embodiments discussed below may be incorporated into any type of engine and/or combustion system.

During operation, air is directed into the compressor system 102 via an air inlet 112. In the depicted embodiment, the compressor system 102 is a single-stage, high-pressure ratio centrifugal compressor system. However, it will be appreciated that this is merely an exemplary embodiment, and that other types of compressors could also be used. In any event, the compressor system 102 raises the pressure of the air and directs the compressed air into the combustion system 104. In the combustion system 104, the high pressure air is mixed with fuel and combusted to generate high-energy combusted air. The combusted air is then directed into the turbine system 106. The combustion system 104 will be discussed in greater detail below.

The turbine system 106 may have one or more turbine rotors disposed in axial or radial flow series, including high pressure and low pressure turbines. The combusted air from the combustion system 104 expands through each turbine rotor, causing it to rotate, and the gas is then exhausted from the engine 100 via an exhaust gas outlet 116. As the turbine rotors rotate, they drive, via a turbine shaft 118, various types of equipment that may be mounted in, or coupled to, the engine 100. For example, in the depicted embodiment, the turbine system 106 drives the compressor system 102. It will be appreciated that the turbine system 106 may also be used to drive a generator, a load compressor and/or other rotational equipment, which are not shown in FIG. 1 for ease of illustration.

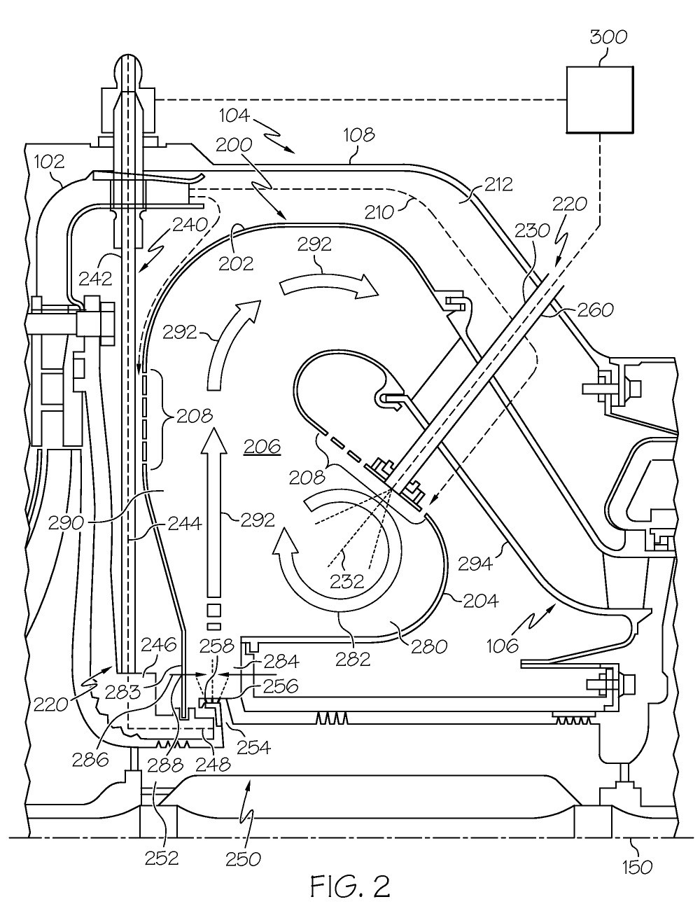

FIG. 2 is a cross-sectional view of an exemplary combustion system, such as the combustion system 104 that may be used in the engine 100 of FIG. 1. As shown, the combustion system 104 may be implemented as a radial-annular combustion system extending about longitudinal axis 150.

The combustion system 104 includes a combustor 200, a fuel delivery system 220, and an igniter 260. The combustor 200 includes a forward annular liner 202 and an aft annular liner 204 spaced apart from one another to form a combustion chamber 206. The forward and aft liners 202, 204 each include a plurality of air inlet orifices 208 (only some of which are shown) and a plurality of effusion cooling holes (not illustrated). Compressed air 210 from the compressor system 102 flows through a plenum 212 between the case 108 and the combustor 200 and into the combustion chamber 206 via the air inlet orifices 208 in both the forward and aft liners 202, 204 to support the combustion process, as discussed in greater detail below. Compressed air 210 also flows into the combustion chamber 206 via the effusion cooling holes. The primary purpose of these holes, however, is to provide effusion cooling to the liners 202, 204.

The fuel delivery system 220 includes a pilot fuel injector 230, a main fuel injector 240, a rotary fuel slinger unit 250, and a fuel controller 300, which is shown schematically. The fuel controller 300 generally controls the flow of fuel and the actuation of the fuel delivery system 220. The fuel controller 300 may include any suitable processing and memory components for receiving an indication of desired power or combustion volume and delivering the appropriate amount of fuel via the other components of the fuel delivery system 220, as discussed below. The fuel controller 300 may form part of a larger engine controller (not shown).

The pilot fuel injector 230 extends through the plenum 212 to the aft liner 204 and, upon a command from the fuel controller 300, delivers a flow of pilot fuel 232 from a non-illustrated fuel source directly into the combustion chamber 206. The pilot fuel 232 is ignited by the igniter 260 to support the combustion process. In general, the igniter 260, which may be any one of numerous types of igniters actuated by an engine controller (not illustrated). In response to an ignition command, the igniter 260 generates a spark of suitable energy, which ignites the fuel-air mixture in the combustion chamber 206, as discussed in greater detail below. Although only one pilot fuel injector 230, main fuel injector 240, and igniter 260 are shown, any number may be provided about the annular combustor 200.

The main fuel injector 240 includes a fuel supply tube 242 that extends through the plenum 212 and, upon a command from the fuel controller 300, delivers a source of main fuel 244 to a fuel housing 246. The fuel supply tube 242 may be configured with sufficient flexibility to allow for any thermal mismatches that may occur between other components and systems in the engine 100 during operation. In the depicted embodiment, the fuel housing 246 is configured as a circumferential cavity, though it will be appreciated that other configurations could also be used. The fuel housing 246 includes a plurality of equally spaced holes 248, through which the main fuel 244 is jetted to the slinger unit 250.

The slinger unit 250 includes a coupler shaft 252, a vertical shoulder 254, and a slinger 256. The coupler shaft 252 is coupled to the turbine shaft 118 and rotates therewith. The vertical shoulder 254 is coupled to, and may be formed as an integral part of, the coupler shaft 252, and thus rotates with the coupler shaft 252. The main fuel 244 that is jetted through the holes 248 in the fuel housing 246 impinges onto the vertical shoulder 254. Because the vertical shoulder 254 rotates with the coupler shaft 252, the impinging fuel acquires the tangential velocity of the coupler shaft 252 and gets centrifuged into the slinger 256.

The slinger 256 is coupled to, and may be formed as an integral part of, the vertical shoulder 254, and thus also rotates with the coupler shaft 252. In the depicted embodiment, the slinger 256 has a substantially cup-shaped radial cross section, and includes a plurality of relatively small, equally spaced holes or slots 258. As the slinger 256 rotates, main fuel 244 is centrifuged through these holes 258, which atomize the main fuel 244 into tiny droplets.

The main fuel 244 from the slinger 256 is initially introduced into a premixing zone 284. As depicted, the premixing zone 284 may be defined by portions of the forward liner 202 and the aft liner 204 as a passageway or duct 283 coupled to the combustion chamber 206. In other embodiments, the duct 283 that defines the premixing zone 284 is formed by additional components may be affixed to the forward liner 202 and aft liner 204.

As the main fuel 244 enters the premixing zone 284, air jets 286 flow through holes 288 in the forward liner 202 and aft liner 204 to rapidly create a fuel and air mixture. This mixing is enhanced by the design of the holes 288 and the evenly distributed fuel 244 from the slinger 256. In effect, the slinger 256 provides the injection of a thin, continuous sheet of fuel, in contrast to the injection that would be provided by a conventional discrete and segregated pattern of injectors arranged in circumferentially in an annular combustor. The air jets 286 additionally prevent the fuel and air mixture from being combusted while residing in the premixing zone 284, thereby further ensuring adequate mixing of the fuel and air. The premixing duct 283 may have any suitable length that enables the air jets 286 to adequately mix with the main fuel 244. The fuel and air mixture is then directed into the combustion chamber 206. In one exemplary embodiment, the residence time for premixing may be maintained less than an ignition delay time of the mixture, which is a function of the operating condition and fuel type, and long enough to achieve the desired vaporization & mixing. Although FIG. 2 illustrates the premixing zone 284 at a position offset from the combustion chamber 206, the premixing zone 284 may also be provided within the combustion chamber 206, i.e., without a separate premixing duct 283. In such an embodiment, the slinger 256 provides vaporized main fuel 244 to the combustion chamber 206, and jets in the forward and/or aft liners 202, 204 immediately mix the fuel with air prior to combustion in the lean combustion zone 290.

The combustion process within the combustion chamber 206 will now be described in greater detail. During operation of the engine 100, the fuel controller 300 operates the fuel delivery system 220 in at least two modes, depending on the load range on the engine 100. The first operating mode is used at low loads, such as during idle or start-up. In this first mode, pilot fuel 232 is supplied only to the pilot fuel injector 230 and delivered to the combustor 200, and no fuel is supplied via the main fuel injector 240. As such, pilot fuel 232 is directly injected and ignited by the igniter 260. Simultaneously, compressed air 210 enters the combustion chamber 206 through air inlet orifices 208 and is combusted in the pilot zone 280.

The combustion process in the pilot zone 280 has a richer fuel to air ratio than stoichiometric, i.e., the ratio of fuel to air is relatively high. Due to the volume of pilot fuel 232 and the geometry of the combustion chamber 206 and air inlet orifices 208, the combustion gases in the pilot zone 280 generally form a toroidal recirculation pattern, as indicated by arrows 282. The rich ratio in the pilot zone 280 is particularly advantageous for reliable high altitude starting performance of the engine 100. The pilot zone 280 creates a continuous ignition and stabilization source for fuel and air entering the combustion chamber 206. Utilizing only the pilot fuel 232 in this mode permits the combustor 200 to maintain low power operating efficiency and to control and minimize emissions during engine low power operations.

As gas turbine engine 100 is accelerated from low load operating conditions to increased power operating conditions, additional fuel and air are provided to combustor 200. In particular, the engine 100 transitions into a second operating mode in which main fuel 244 is provided into the combustion chamber 206 through the main fuel injector 240 and slinger unit 250. As noted above, the main fuel 244 is mixed with air from jets 286 in the premixing zone 284 prior to combustion. This mixing ensures that the fuel and air mixture entering the other portions combustion chamber 206 has a leaner than stoichiometric ratio, i.e., the ratio includes excess air. The improved fuel atomization from the slinger unit 250 enhances the mixing, and thus, the homogeneous lean ratio. During this second mode, the flow of pilot fuel 232 may be maintained, reduced, or eliminated.

The lean mixture enters a lean combustion zone 290 where it is ignited by the combustion gases 282 in the rich pilot zone 280. The resulting combustion gases in the lean combustion zone 290 are indicated by arrows 292. As the combustion gases 292 flow through the lean combustion zone 290, combustion is stabilized and the lean ratio maintains combustion temperatures at a relatively low level that reduces or prevents formation of NOx. The high level of mixing in the premixing zone 284 further enhances the lean combustion by ensuring that all areas of the fuel and air mixture burn at the appropriate temperature, i.e., by reduces or prevents hot spots of fuel. In one exemplary embodiment, stoichiometry in the lean combustion zone 290 may be targeted to achieve a bulk average of about 1800K to minimize NOx, although other ratios and temperatures may be provided.

The high-energy combusted gas from the lean combustion zone 290 is then directed to the turbine system 106 via a turbine inlet nozzle 294. As noted above, the combustion gases 292 drive the turbines in the turbine system 106 to drive the turbine shaft 118. The increased volume of combustion gases 282 in the lean combustion zone 290 provides the desired level of increased power capacity.

As noted above, the lean ratio of the lean combustion zone 290 has a reduced temperature relative to a conventional stoichiometric or rich combustion zone. The reduced temperatures provide advantageously lower NOx emissions, particularly without the added resources and expenses of post-combustion treatment of the combustion gases. While NOx emissions are reduced, the pilot zone 280 maintains acceptable ignition performance during low power conditions. The use of the slinger 256 eliminates the fuel nozzles and associated manifold components in the premixing zone 284 and the lean combustion zone 290, thereby reducing part count, lowering acquisition costs, increasing reliability, improving maintainability, and reducing operating expenses. Although the discussion above refers to operating the engine in a low load operating mode or a high load operating mode, the flow of main fuel 244 relative to pilot fuel 232 may be continually monitored and adjusted based on varying operating conditions. As such, the engine 100 may have selective actuation of the pilot fuel injector 230 and the main fuel injector 240 to provide optimal NOx emission and ignition characteristics.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A combustion system for a gas turbine engine, the combustion system comprising:
a forward liner;
an aft liner;
a combustion chamber formed by the forward liner and the aft liner, the combustion chamber defining a lean combustion zone and a pilot combustion zone;
a premixing zone coupled to the combustion chamber;
a pilot fuel injector coupled to the combustion chamber and configured to deliver a first flow of fuel to the pilot combustion zone; and
a slinger unit configured to deliver a second flow of fuel to the premixing zone such that the second flow of fuel is mixed with air in the premixing zone and directed into the lean combustion zone of the combustion chamber.

2. The combustion system of claim 1, wherein the premixing zone is formed by a premixing duct coupled to the forward liner and the aft liner.

3. The combustion system of claim 1, wherein the premixing zone is formed by the forward liner and the aft liner.

4. The combustion system of claim 1, further comprising a main fuel injector configured to provide the second flow of fuel to the slinger unit.

5. The combustion system of claim 4, wherein the slinger unit comprises
a coupler shaft configured to rotate along a longitudinal axis;
a vertical shoulder coupled to and configured to rotate with the coupler shaft, the vertical shoulder further configured to receive an impingement of the second flow of fuel from the main fuel injector; and
a slinger coupled to the vertical shoulder and defining a plurality of slinger holes, the slinger configured to rotate with the vertical shoulder such that the second flow of fuel flows into the slinger and through the slinger holes at a tangential velocity sufficient to vaporize the second flow of fuel.

6. The combustion system of claim 5, wherein the slinger has a substantially cup-shaped radial cross section.

7. The combustion system of claim 1, further comprising a fuel controller configured to selectively operate the slinger unit and the pilot fuel injector in a first mode and a second mode.

8. The combustion system of claim 7, wherein,
the fuel controller, in the first mode, is configured to operate the slinger unit and the pilot fuel injector such that only the first flow of fuel is delivered to the combustion chamber, and
the fuel controller, in the second mode, is configured to operate the slinger unit and the pilot fuel injector such that the first flow of fuel is delivered to the combustion chamber and the second flow of fuel is delivered to the premixing duct.

9. The combustion system of claim 1, further comprising a fuel controller configured to independently actuate the pilot fuel injector and the slinger unit to selectively deliver the first flow of fuel and the second flow of fuel.

10. The combustion system of claim 1, further comprising holes positioned in the premixing duct and configured to direct the air into the premixing zone.

11. The combustion system of claim 10, wherein the holes are configured to direct an amount of mixing air into the premixing zone sufficient to produce a lean fuel-air mixture.

12. A method of delivering fuel to a combustion chamber defining a lean combustion zone and a pilot combustion zone, the method comprising the steps of:
delivering a first flow of fuel to the pilot combustion zone with a pilot fuel injector;
delivering a second flow of fuel to a premixing duct coupled to the combustion chamber and defining a premixing zone;
mixing the second flow of fuel with air to produce a lean fuel-air mixture; and
delivering the lean fuel-air mixture to the lean combustion zone.

13. The method of claim 12, further comprising the step of selectively operating the combustion chamber in a first mode and a second mode, wherein
the first mode includes the step of delivering the first flow of fuel, and
the second mode includes the step of delivering the second flow of fuel.

14. The method of claim 13, wherein the delivering the second flow of fuel step includes:
delivering the second flow of fuel with a slinger unit.

15. The method of claim 12, further comprising the step of:
directing a first flow of air into the pilot combustion zone such that a rich fuel-air mixture is formed.

16. The method of claim 12, further comprising the step of:
igniting the first flow of fuel with an igniter.

17. The method of claim 16, wherein the igniting step includes:
igniting the first flow of fuel such that a toroidal recirculation pattern of rich combustion gases forms in the pilot combustion zone.

18. The method of claim 17, further comprising the step of:
igniting the lean fuel-air mixture with the rich combustion gases to form lean combustion gases in the lean combustion zone.

19. The method of claim 12, wherein the step of mixing the second flow of fuel with the air includes
directing air jets through the premixing duct into the premixing zone.

20. A combustion system for a gas turbine engine, the combustion system comprising:
a forward liner;
an aft liner forming a combustion chamber with the forward liner, the combustion chamber defining a lean combustion zone and a pilot combustion zone;
a premixing duct coupled to the combustion chamber and defining a premixing zone;
a pilot fuel injector coupled to the combustion chamber and configured to deliver a first flow of fuel to the pilot combustion zone;
a main fuel injector configured to provide the second flow of fuel to the slinger unit;
a slinger unit configured to receive the second flow of fuel from the main fuel injector and deliver the second flow of fuel to the premixing zone such that the second flow of fuel is mixed with air in the premixing zone and directed into the lean combustion zone of the combustion chamber, the slinger unit comprising
a coupler shaft configured to rotate along a longitudinal axis;
a vertical shoulder coupled to and configured to rotate with the coupler shaft, the vertical shoulder further configured to receive an impingement of the second flow of fuel from the main fuel injector; and
a slinger coupled to the vertical shoulder and defining a plurality of slinger holes, the slinger configured to rotate with the vertical shoulder such that the second flow of fuel flows into the slinger and through the slinger holes at a tangential velocity sufficient to vaporize the second flow of fuel; and
a fuel controller configured to independently actuate the pilot fuel injector and the slinger unit to selectively deliver the first flow of fuel and the second flow of fuel.
